(19) United States
(12) Patent Application Publication
(10) Pub. No.: US 2020/0164465 A1
(43) Pub. Date: May 28, 2020

(54) COMPONENT, AND FILLING OF A DEFECT BY MEANS OF ALTERNATE BRAZE METAL AND PARENT MATERIAL LAYERS

(71) Applicant: SIEMENS AKTIENGESELLSCHAFT, Munchen (DE)

(72) Inventor: BERND BURBAUM, FALKENSEE (DE)

(21) Appl. No.: 15/765,519

(22) PCT Filed: Sep. 12, 2016
(86) PCT No.: PCT/EP2016/071401

§ 371 Date: Apr. 3, 2018

(30) Foreign Application Priority Data
Oct. 7, 2015 (DE) 10 2015 219 345.4

(51) Int. Cl. B23K 26/342; B23K 26/144; B23P 6/00; F01D 5/00

(52) U.S. Cl. CPC B23K 26/342; B23K 26/144; F05D 2230/30; F01D 5/005; F05D 2230/234; B23P 6/007

(57) ABSTRACT

Provided is a part and to the filling, layer by layer, of a defective spot by means of solder and parent metal. Because a defective spot is filled layer by layer, good mechanical properties are obtained for the defective spot and the entire part.

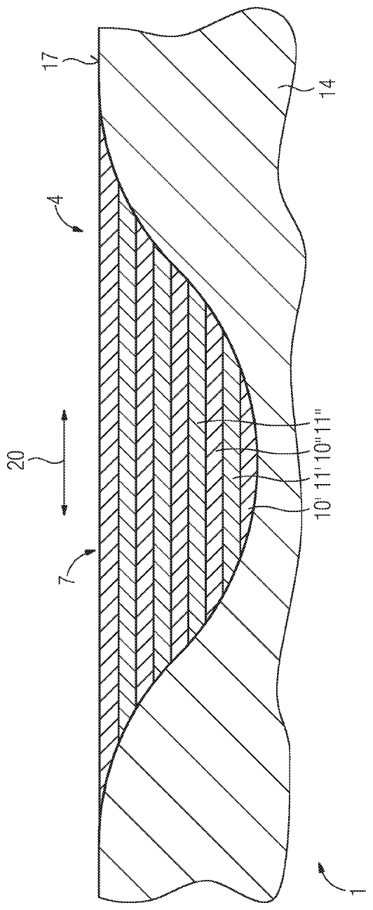

### CROSS-REFERENCE TO RELATED APPLICATIONS

This application claims priority to PCT Application No. PCT/EP2016/071401, having a filing date of Sep. 12, 2016, based on German Application No. 10 2015 219 345.4, having a filing date of Oct. 7, 2015, the entire contents both of which are hereby incorporated by reference.

### FIELD OF TECHNOLOGY

The following relates to the filling of a defect, in which use is made, layer by layer, of a braze metal and a parent material or a material similar to the parent material in order to fill the defect.

### BACKGROUND

The concept relates to a coating repair, in particular by means of laser beam deposition welding of components in combination with a braze metal. This process uses materials. These are materials having a large fraction of intermetallic phase, e.g. Rene80 and a similar braze metal. During deposition welding using a high-speed powder switch, it is possible to switch back and forth at high speed between at least two powder flows having different chemical compositions, so that the chemical composition of the deposited material changes seamlessly and there is no interruption of the powder flow in the melt bath. It is thus also possible to use, in addition to the powder consisting of the parent materials (e.g. Rene80), similar braze metals as filler materials for the laser beam deposition welding.

Hitherto, there have been no coating methods for nickel-based superalloys with a large fraction of intermetallic phase, such as Rene80 and In738. In the context of coupon repair by brazing, the parent material and the filler material are mixed and formed into a coupon.

### SUMMARY

The embodiment therefore has the object of solving the abovementioned problem.

Further advantageous measures, which can be combined as desired with one another to achieve further advantages, are listed in the dependent claims.

### BRIEF DESCRIPTION

Some of the embodiments will be described in detail, with reference to the following FIGURES, wherein like designations denote like members, wherein:

The FIGURE shows a component according to the invention, and the procedure according to the invention.

### DETAILED DESCRIPTION

The FIGURE and the description represent only exemplary embodiments of the invention.

In a damaged region of a turbine blade, as an example of a component, concave geometries are formed, and therefore cracks and oxides are completely removed for subsequent coating. The pre-prepared concave geometries are then re-filled, preferably by laser beam deposition welding using two materials. In that context, the parent material is added once to the melt bath. The second material used is a similar material, used hitherto for narrow-gap brazing of cracks in these parent materials. The two materials are deposition welded layer by layer one on top of the other, so that the deposition-welded layers are oriented in the principal loading direction. In order to switch rapidly between the two materials, it is possible to use a high-speed powder switch during the welding process. During the welding of the parent material, the large fraction of intermetallic phase causes hot crack formation in the welded material. In a final heat-treatment after the welding process, these hot cracks are closed by the braze metal and a crack-free structure is obtained.

The advantages are improved material properties of the component compared to conventionally welded components and identical coefficient of thermal expansion owing to the like-for-like repair.

The FIGURE shows a component 1 with a defect 4.

The component 1 can be any metal component. In particular, the component is a high-temperature component, particularly of a turbine and very particularly of a gas turbine, which then has a nickel-based or cobalt-based superalloy.

In the context of new production, or in the context of reconditioning, there is a defect 4 which does not have enough material and which has to be re-filled. In this exemplary embodiment, this is a trough. However, the shape of the defect 4 is not restrictive, that is to say that a flank can also be open and have no side face.

A substrate 14 of this component 1 has a certain material that has a certain melting point.

A braze metal has, in addition to the parent material, melting point depressors such as boron (B), silicon (Si), germanium (Ge), magnesium (Mg), manganese (Mn), or another composition which has a melting point that is at least 10K, in particular 20K, lower than that of the parent material.

With regard to the parent material, it is also possible to consider material similar to the parent material, which then has another composition and another melting point than the parent material of the substrate 14, but which still has a melting point at least 10K, in particular 20K, higher than that of the braze metal.

The defect 4 is filled, in an alternating layer-by-layer manner, with a parent material or a material similar to the parent material and a braze metal. This involves, for example, starting with one layer or undercoat 10′ of a braze metal onto which the parent material or the material similar to the parent material is deposited as a layer 11′. This is continued in alternation until the defect 4 is completely filled and is then provided with a filling 7. The thickness of the individual layers 10′, 11′, 10″, 11″, . . . can vary with respect to one another and also along the build-up direction up to the outer surface 17.

The individual layers 10′, 11′, 10″, 11″, . . . are produced by a deposition welding process, particularly a powder deposition welding process and very particularly a laser powder deposition welding process. In that context, the individual tracks are laid such that they are oriented optimally with respect to the later loading direction 20.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1-3. (canceled)

4. A component having a filled defect, comprising:
a substrate with the defect, wherein the substrate has a parent material;
wherein the defect is filled, in an alternating layer-by-layer manner, with a parent material or a material similar to the parent material and a braze metal, in which a melting point of the braze metal is at least 10K, in particular at least 20K, lower than that of the parent material; or material similar to the parent material
wherein the layers for the layer-by-layer filling are produced by a powder deposition welding process.

5. A method for filling a defect for producing a component, the method comprising:
filling a defect in a substrate made of a parent material, in an alternating layer-by-layer manner, with a parent material or a material similar to the parent material and a braze metal, until the defect is entirely filled;
wherein a melting point of the braze metal is at least 10K lower than that of the parent material or material similar to the parent material;
wherein the layers for the layer-by-layer filling are produced by a powder deposition welding process.

6. The component of claim 4, wherein the melting point of the braze metal is at least 20K lower than that of the parent material.

7. The component of claim 4, wherein the powder deposition welding process is a laser powder deposition welding process.

8. The method of claim 5, a melting point of the braze metal is at least 20K lower than that of the parent material.

9. The method of claim 5, wherein the powder deposition welding process is a laser powder deposition welding process.
